(19) United States
(12) Patent Application Publication
(10) Pub. No.: US 2005/0285975 A1
(43) Pub. Date: Dec. 29, 2005

(54) Software implementing parts of a blanking interval encoder/decoder

(75) Inventors: Evgeny Spektor, Petach-Tikva (IL); Gennady Mayko, Herzliya (IL); Ronit Hadar, Modi'in (IL); Alon Rachmani, Rehovot (IL)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 11/159,253

(22) Filed: Jun. 23, 2005

Related U.S. Application Data
(60) Provisional application No. 60/582,863, filed on Jun. 28, 2004.

(51) Int. Cl. H04N 11/00

(52) U.S. Cl. 348/465; 348/468

(57) ABSTRACT

A blanking interval information decoder is described, with the blanking interval decoder being adapted for decoding blanking interval information transmitted in a video signal. The blanking interval information decoder comprises a processing unit, a memory adapted for storing at least one of code and data, and a set of blanking interval decoding routines stored in the memory. Each of the blanking interval decoding routines is adapted for decoding a certain type of blanking interval information of a certain video standard.

### CROSS-REFERENCE TO RELATED APPLICATIONS

This application claims benefit to U.S. Provisional application 60/582,863, filed Jun. 28, 2004, which is incorporated by reference herein in its entirety.

### FIELD OF THE INVENTION

The present invention relates to a blanking interval information decoder adapted for decoding blanking interval information transmitted in a video signal. The invention further relates to a video signal encoding unit and to a blanking interval information encoder. Be-sides that, the invention relates to a method for extracting and decoding blanking interval information transmitted as part of a video signal, and to a method for updating blanking interval decoding routines.

### BACKGROUND OF THE INVENTION

During blanking intervals of a TV or video signal, a variety of different types of information may be transmitted. Up to now, a lot of different types of blanking interval information have been defined, with different modulation and encoding schemes being used by the different types of blanking interval information. Information transmitted during a TV signal's blanking intervals might e.g. comprise auxiliary information related to the TV signal's audiovisual contents, like e.g. closed captions (CC). Blanking interval information might further comprise data required for programming video recorders (e.g. VPS, video programming system), or data related to copy protection (e.g. CGMS, copy generation management system).

In prior art solutions, dedicated decoders have been provided for each type of blanking interval information required by a certain audio/video device.

It is an object of the invention to simplify the decoding and encoding of blanking interval information.

### SUMMARY OF THE INVENTION

A system and/or method for at least one of decoding and encoding blanking interval information, substantially as shown in and/or described in connection with at least one of the figures, as set forth more completely in the claims.

### BRIEF DESCRIPTION OF THE DRAWINGS

FIG. 1 shows a video signal encoder adapted for encoding audiovisual contents and for decoding blanking interval information;

FIG. 2 shows a set-top box comprising a video signal encoder according to embodiments of the present invention;

FIG. 3 shows an apparatus for realizing an alternative embodiment of the present invention;

FIG. 4 illustrates a motherboard mounted into the apparatus of FIG. 3, said motherboard comprising a CPU and respective memory components; and

FIG. 5 illustrates a video and/or audio data processing card, which might be plugged into the apparatus shown in FIG. 3.

### DETAILED DESCRIPTION

The present invention provides a blanking interval information decoder adapted for decoding blanking interval information transmitted in a video signal. The blanking interval information decoder comprises a processing unit, a memory adapted for storing at least one of code and data, and a set of blanking interval decoding routines stored in the memory. Each of the blanking interval decoding routines is adapted for decoding a certain type of blanking interval information of a certain video standard.

Blanking interval information is transmitted during blanking intervals of a video or television signal. There exist a large number of different types of blanking interval information, with each type of blanking interval information being encoded in a different way. Further-more, during one blanking interval, several different types of blanking interval information might be transmitted.

In blanking interval information decoders of the prior art, for each type of blanking interval information, a dedicated decoding unit has been provided, with each of the decoding units being adapted for decoding one specific type of blanking interval information. A decoder has only been capable of decoding a predefined set of types of blanking interval information.

Instead of providing a set of hard-wired decoding units for blanking interval information, the decoding is performed by means of decoding routines stored in a memory, whereby each of the decoding routines is adapted for decoding one specific type of blanking interval information. The memory may comprise a large variety of different decoding routines suited for decoding video signals of different video standards. Hence, a blanking interval information decoder according to embodiments of the present invention may process a large variety of different types of blanking interval information. Compared to prior art solutions, the hardware expenditure is rather small.

Furthermore, a new degree of flexibility is gained. Decoding routines stored in the memory may be replaced by update versions, whereby the update versions might e.g. comprise bug fixes, additional features, etc. Besides that, new decoding routines related to new types of blanking interval information may be loaded to the memory. Thus, the decoding performed by the blanking interval information decoder is not limited to a predetermined set of types of blanking interval information any more. Instead, new decoding routines might be downloaded, and then, the decoder is capable of decoding types of blanking interval in-formation that might not have been defined yet when the respective device has been purchased. By updating the set of decoding routines, the user may take advantage of new features based on new types of auxiliary blanking interval information.

According to a preferred embodiment, the blanking interval information decoder further comprises an identification routine stored in the memory, said identification routine being adapted for detecting the one or more types of encoded blanking interval information, and for activating, in accordance with the detected types of blanking interval information, corresponding blanking interval decoding routines. For example, the identification routine may be implemented as a main routine adapted for analyzing the types of blanking interval information contained in the blanking interval and for calling the corresponding decoding routines. A blanking interval decoding routine will only be called if the corresponding type of blanking interval information is present in the blanking interval. Only those decoding routines required for decoding the blanking interval information contained in the video signal are executed. Thus, the computational expense is kept as small as possible.

According to a further preferred embodiment of the invention, the identification routine is adapted for analyzing active lines of the blanking interval, and for activating those blanking interval decoding routines adapted for decoding the types of blanking interval information contained in the blanking interval. A blanking interval may comprise a multitude of active lines. Hence, within one blanking interval, several different types of blanking information may be transmitted simultaneously. For each of these types of blanking interval information, a corresponding decoding routine is called, said decoding routine being adapted for decoding the specific type of blanking interval information and for providing decoded blanking interval information.

In a preferred embodiment, the identification routine is further adapted for analyzing the video signal's respective video standard. The decoding procedure might depend on the transmitted signal's video standard, which might determine the way the blanking information is modulated. In this case, the identification routine might e.g. select a suitable decoding routine both in accordance with the type of blanking interval information and with the video signal's standard. Then, a decoding routine adapted for decoding the detected type of decoding information transmitted in the respective video standard is called.

Preferably, the video standard is one of: PAL, NTSC, SECAM, or any other type of video standard.

According to a preferred embodiment, the set of blanking interval decoding routines and the identification routine are implemented as software routines. In prior art solutions, blanking interval information decoders have been realized using dedicated hardware units, with each of the dedicated hardware units being adapted for decoding a specific type of blanking interval information. Thus, it has only been possible to decode a fixed set of types of blanking interval information. By realizing the decoding routines and the identification routine in software, a new degree of flexibility is provided for. For example, in order to decode new types of blanking information, new decoding routines may be downloaded to the memory. Furthermore, an existing version of a decoding routine may be replaced by an update version of this decoding routine. Hence, the set of blanking interval information decoding routines can be modified and adapted to the respective decoding needs. The blanking interval information decoding hardware becomes more versatile, and new types of blanking interval information can be processed.

In another preferred embodiment, the set of blanking interval decoding routines and the identification routine are realized in microcode. Microcode routines stored in the memory can be carried out at high speed by the processing unit. In fact, the processing speed of microcoded instructions is very close to the processing speed of hard-wired instructions.

According to a preferred embodiment of the invention, the blanking interval information is one of: vertical blanking interval (VBI) information and horizontal blanking interval (HBI) information. In analogue video or television signals, the vertical blanking interval (VBI) is the time interval when the beam position jumps e.g. from the last line (in particular, the right end of the last line) of a picture to the first line (in particular, the left end of the first line) of the—next—picture. During the vertical blanking interval, auxiliary information may be transmitted. The horizontal blanking interval (HBI) denotes the time interval when the beam jumps e.g. from the end of a line (in particular, the right end of a line) to the be-ginning of the next line (in particular, the left end of the next line). The horizontal blanking interval (HBI) can also be utilized for transmitting auxiliary information.

In a preferred embodiment, the memory is a RAM memory. Thus, the identification routine and the decoding routines can be replaced and reloaded whenever this is appropriate. Any set of decoding routines required for decoding predefined types of blanking interval information can be stored in the RAM memory. Thus, the set of decoding routines stored in the memory can be adapted to the respective decoding needs.

In a further preferred embodiment, the blanking interval information decoder further comprises an updating module adapted for downloading at least one of: new blanking interval decoding routines adapted for decoding previously unknown types of blanking interval information and update versions of existing blanking interval decoding routines. The routines might e.g. be downloaded via an RS 232 interface, via an Ethernet connection, via an USB port, from CD ROM, etc. The updating module might e.g. be capable of removing former versions, and for installing update versions of the decoding routines.

In a preferred embodiment, the blanking interval information comprises one or more of the following types: closed captions (CC), teletext (TTX), wide screen signaling (WSS), copy generation management system (CGMS), video programming system (VPS), program de-livery control (PDC), or any other type of blanking interval information. There exist a variety of other types of blanking interval information. Up to now, tens of different types of blanking interval information have been defined, with different encoding and modulation schemes being used by each of these types. In contrast to decoders of the prior art, the blanking interval information decoder according to embodiments of this invention can be used for decoding types of blanking interval information that might not even exist yet. Thus, it is possible to take advantage of features that are not known when the electronic device is built.

In a preferred embodiment of the invention, the blanking interval information decoder is implemented as an integrated circuit. The at least one processing unit and the memory can be integrated on an application-specific integrated circuit (ASIC). After the desired decoding routines needed for decoding certain types of blanking interval information have been loaded to the memory, an integrated circuit of this kind can be used for decoding any kind of auxiliary blanking interval information.

According to a preferred embodiment, the blanking interval information decoder is part of a set-top box, a personal video recorder, a digital video recorder, a digital television set, a video and/or audio processing card. A blanking interval information decoder according to embodiments of the present invention can be used for extracting and processing blanking interval information in any electronic appliance that processes analogue video or television signals.

The present invention further provides a video signal encoding unit comprising an extraction module adapted for extracting audiovisual content and blanking interval information from a video signal, and a blanking interval information decoder as described above, with the blanking interval information decoder being adapted for decoding blanking interval information. The video signal encoding unit further comprises an audiovisual information converter adapted for converting the audiovisual content into a digital audio/video format.

First, the blanking interval information is separated from the video signal's audiovisual content. The above-described blanking interval information decoder is responsible for de-coding the blanking interval information, and for providing a stream of decoded blanking interval information. The audiovisual information converter is responsible for converting the video signal's audiovisual content into a suitable digital video format. Hence, the video signal encoding unit is capable of providing two different kinds of digital data streams: a first digital data stream containing the video signal's audiovisual content, and another digital data stream comprising auxiliary information extracted from the video signal's blanking intervals, like e.g. closed captions.

In a preferred embodiment, the video signal encoding unit comprises an analogue-to-digital converter adapted for converting the video signal into a sequence of digital sample values. Before an analogue video or television signal can be subjected to digital signal processing, it is necessary to perform an analogue-to-digital conversion of the analogue video or television signal, in order to generate a sequence of digital samples.

According to another preferred embodiment, the audiovisual information converter is an MPEG encoding module adapted for converting the audiovisual content into an MPEG stream. The standards defined by the Moving Picture Expert Group provide an audio-visual coding standard for allowing content-based interactivity, improved coding efficiency and/or universal accessibility. Due to the high level data compression, these standards are well-suited for low-bit rate communications.

According to a further preferred embodiment, the video signal encoding unit is adapted for inserting decoded blanking interval information into the digital audio/video format. For example, in an MPEG data stream, there exist user data portions that can be used for accommodating auxiliary information like e.g. decoded blanking interval information. By inserting the decoded blanking interval information into the digital bit stream, one digital bit stream comprising both the audiovisual content and the auxiliary blanking interval in-formation is set up.

According to a preferred embodiment, the audiovisual information converter is implemented as a software routine stored in the memory. In this embodiment, the memory comprises decoding routines adapted for decoding certain types of blanking interval information and an audiovisual information converting routine adapted for converting audiovisual contents into a digital audio/video format. For example, the memory may comprise an MPEG encoding routine. Hence, the entire video signal encoding unit can be realized by means of a memory comprising a multitude of different routines and one or more processing units that access the memory.

According to an alternatively preferred embodiment, the audiovisual information converter is implemented as a hardware unit. For example, in this embodiment, the video signal en-coding unit might comprise a separate MPEG encoder realized as a hardware unit. In terms of performance, this solution might permit a superior performance. In this embodiment, encoding of audiovisual content can be performed while simultaneously decoding blanking interval information.

In yet another preferred embodiment, the video signal encoding unit is implemented as a system on a chip. In this embodiment, the extraction module, the blanking interval information decoder and the audiovisual information converter are integrated on one chip, said chip being responsible for converting an analogue video or television signal into one or more digital bit streams. A chip of this kind can be used for decoding any type of blanking interval information.

In a preferred embodiment, the video signal encoding unit is part of a set-top box, a personal video recorder, a digital video recorder, an audio and/or video processing card.

The present invention further provides a blanking interval information encoder adapted for encoding blanking interval information. The blanking interval information encoder comprises a processing unit, a memory adapted for storing at least one of code and data, and a set of blanking interval encoding routines stored in the memory. Each of the blanking interval encoding routines is adapted for encoding the blanking interval information according to a certain type and video standard. The blanking interval information encoder further comprises a selection routine stored in the memory, said selection routine being adapted for activating, in accordance with a desired type of blanking interval information, a corresponding blanking interval encoding routine.

For encoding auxiliary data that is intended to be transmitted during a blanking interval, a suitable encoding routine is selected first. This task is performed by the selection routine. Then, a respective encoding routine responsible for encoding the respective type of blanking interval information is activated. By realizing the blanking interval encoders as soft-ware routines, it is possible to replace an encoding routine by a more recent version, or to add encoding routines related to newly defined standards.

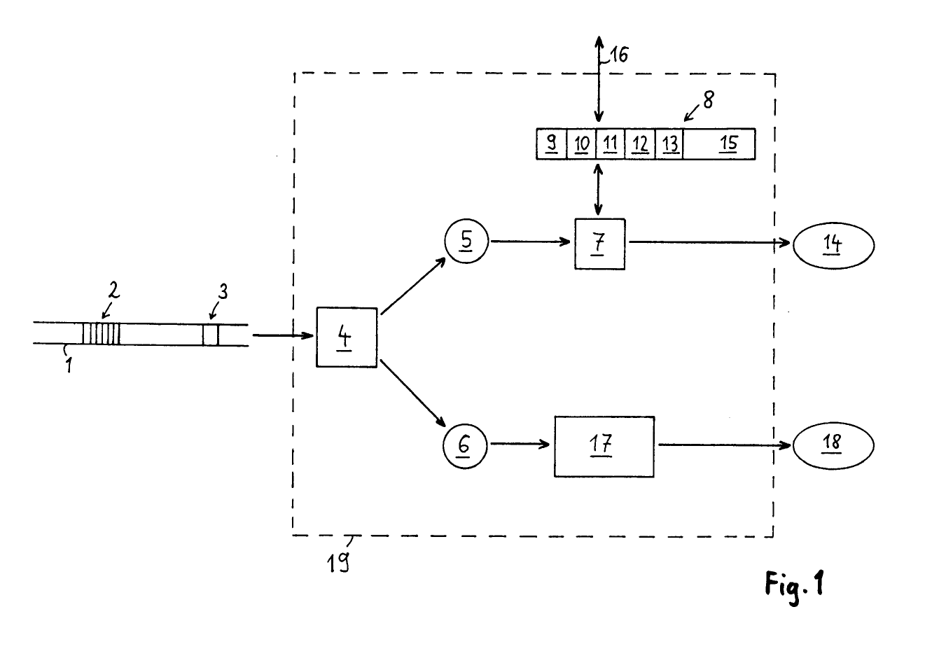

FIG. 1 shows a video signal encoder adapted for converting an analogue video signal 1 to a digital video format. The analogue video signal 1 might e.g. be a signal according to one of the standards PAL, SECAM, NTSC, or to any other kind of analogue colour or black and white video standard. The analogue video signal 1 might comprise vertical blanking intervals (VBI) 2. A vertical blanking interval (VBI) relates to the analogue video signal's “jump” from e.g. the last or bottom line (in particular, the right end of the last or bottom line) of a picture to the first or upper line (in particular, the left end of the first or upper line) of the—next—picture. Furthermore, the analogue video signal 1 might comprise horizontal blanking intervals (HBI) 3, which relate to the analogue video signal's “jump” from e.g. the end of a line (in particular, the right end of a line) to the beginning of the next line (in particular, the left end of the next line).

The video signal's vertical blanking intervals can be used for transmitting auxiliary information, which is transmitted in addition to the video signal's audiovisual content. The length of the vertical blanking interval corresponds to the time needed for transmitting about 20 “lines” of a TV screen for each video field, or about 40 “lines” for each video frame. In addition to the vertical blanking intervals, also the horizontal blanking intervals can be used for transmitting additional data.

There exist a variety of different types of blanking information, with different modulation schemes being used for transmitting these different types of information during the blanking intervals. For example, the blanking intervals may be utilized for transmitting closed captions (CC) that can be displayed together with a movie, or for transmitting teletext (TTX). Furthermore, the blanking intervals may be used for transmitting user-specific in-formation like e.g. program delivery control (PDC) information, or for transmitting copy protection information like e.g. CGMS (Copy Generation Management System). Another example is the transmission of Wide Screen Signaling (WSS) data. Besides that, there exist other types of blanking interval information. For example, up to now, tens of different types of VBI information have been defined, with each type of VBI information being characterized by a certain transmission and modulation scheme. The blanking intervals of an analogue video signal may be used for simultaneously transmitting two or more different types of blanking interval information.

The video signal encoder shown in FIG. 1 comprises an analogue-to-digital converter 4 adapted for converting the analogue video signal 1 into a sequence of digital sample values. Then, in accordance with respective headers, samples related to raw blanking interval data 5 is separated from sample data related to audiovisual content 6.

Next, the raw blanking interval data 5 is decoded. According to embodiments of the pre-sent invention, the blanking interval data decoder comprises a processing unit 7 and a code memory 8 adapted for storing microcode routines. Preferably, the code memory 8 is implemented as a RAM memory. Decoding of the raw blanking interval data 5 is performed by means of a main routine 9 and a set of decoding subroutines 10, 11, 12 stored in the code memory 8. Each of the decoding subroutines 10, 11, 12 is adapted for analyzing one specific type of blanking interval information transmitted in one of the video standards PAL, SECAM, NTSC, or in any other kind of analogue colour or black and white video standard. For example, the decoding subroutine 10 might be adapted for decoding teletext (TTX) information of a PAL signal, whereas the decoding subroutine 11 might be responsible for decoding program delivery control (PDC) information of an NTSC signal.

The processing unit 7 accesses the code memory 8 and executes the main routine 9. The main routine 9 is adapted for analyzing the raw blanking interval data 5, and for identifying the types of blanking interval information contained in the blanking interval. The main routine 9 might as well analyze if the analogue video signal 1 is a PAL signal, a SECAM signal or an NTSC signal. Alternatively, there might exist a separate video standard detection routine 13 adapted for detecting the video signal's transmission standard.

After the main routine 9 has detected a certain type of blanking interval information, a corresponding one of the decoding subroutines 10, 11, 12 is called. The respective decoding subroutine is responsible for performing subsequent decoding. The decoding is performed in accordance with the modulation and timing used for transmitting the respective type of blanking interval information. As a result of the decoding process, decoded blanking interval information 14 is obtained.

A blanking interval might comprise one type of blanking interval information. However, a blanking interval might as well contain several different types of blanking interval information. In this case, several different decoding subroutines are called consecutively.

By implementing the blanking interval decoding routines in microcode, replacement of a certain decoding routine by an update version is simplified. Furthermore, new decoding routines related to new, previously unknown types of blanking interval information can be downloaded to the code memory 8. Thus, whenever a new type of blanking interval information is defined, a corresponding decoding routine can be loaded to free memory space 15 of the code memory 8.

For example, new versions of existing decoding routines or new decoding routines for new types of blanking interval information might be loaded to the code memory via an RS 232 interface 16. Alternatively, an Ethernet connection or a port for an USB stick might be used for receiving a data stream comprising update versions of the decoding routines.

Simultaneously, the sample data related to audiovisual content 6 is forwarded to a conversion unit, which is adapted for converting the audiovisual content into a digital audio/video format.

In digital video and/or video/audio systems such as video-telephone, teleconference and digital television systems, a large amount of digital data is needed to define each video frame signal since a video line signal in the video frame signal comprises a sequence of digital data referred to as pixel values. Since, however, the available frequency bandwidth of a conventional transmission channel is limited, in order to transmit the large amount of digital data there through, it is necessary to compress or reduce the volume of data through the use of various data compression techniques, e.g. as defined in a respective MPEG standard (i.e. a digital coding standard as defined by the Moving Picture Expert Group).

One of such techniques for encoding video signals for a low bit-rate encoding system is an object-oriented analyzis-synthesis coding technique, wherein an input video image is divided into objects and three sets of parameters for defining the motions, the contours, and the pixel data of each object are processed through different encoding channels.

One example of such object-oriented coding scheme is the so-called MPEG (Moving Picture Experts Group) phase 4 (MPEG-4), which is designed to provide an audio-visual coding standard for allowing content-based interactivity, improved coding efficiency and/or universal accessibility in such applications as low-bit rate communications, interactive multimedia (e.g., games, interactive TV and the like) and surveillance (see, for instance, MPEG-4 Video Verification Model Version 2.0, International Organization for Standardization, ISO/IEC JTC1/SC29/WG11 N1260, March 1996).

According to MPEG-4, an input video image is divided into a plurality of video object planes (VOP's), which correspond to entities in a bitstream that a user can have access to and manipulate. A VOP can be referred to as an object and represented by a bounding rectangle whose width and height may be chosen to be smallest multiples of 16 pixels (a macro block size) surrounding each object so that the encoder processes the input video image on a VOP-by-VOP basis, i.e., an object-by-object basis. The VOP includes colour information consisting of the luminance component (Y) and the chrominance components (Cr, Cb) and contour information represented by, e.g., a binary mask.

Hence, in a preferred embodiment, the sample data related to audiovisual content 6 is for-warded to an MPEG encoder 17, and as a result of the encoding, an encoded MPEG stream 18 is obtained. The decoded blanking interval data 14 might be provided as a separate data stream in addition to the encoded MPEG stream 18. Alternatively, the decoded blanking interval data 14 might be inserted into user data portions of the MPEG stream 18. Thus, one digital data stream comprising both the audiovisual content and the auxiliary blanking interval information is obtained.

The MPEG encoder 17 might be realized as a separate hardware unit. In this case, the analogue-to-digital converter 4, the processing unit 7, the code memory 8 and the MPEG en-coder 17 might be integrated on an application-specific integrated circuit 19. Alternatively, the MPEG encoder 17 might be implemented in microcode, with a respective MPEG en-coding routine being stored in the code memory 8. Also in this embodiment, the analogue-to-digital converter 4, the processing unit 7 and the code memory 8 might be integrated on one integrated circuit.

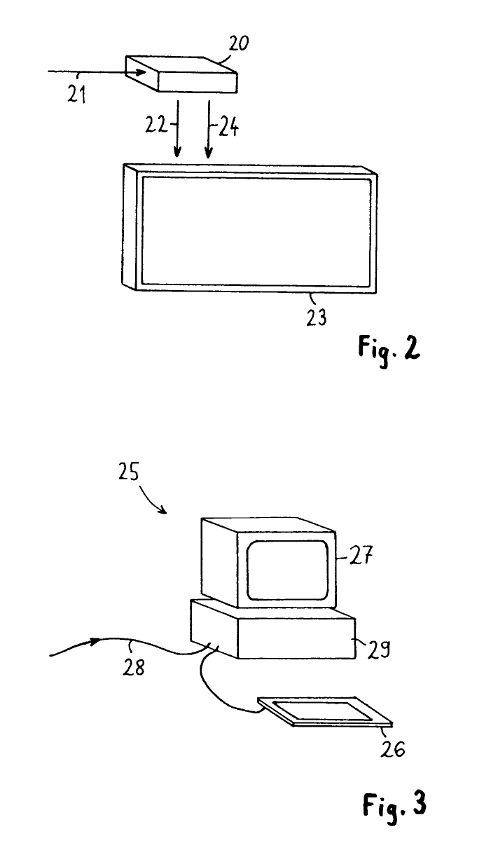

The video signal encoder according to embodiments of the present invention might e.g. be employed in set-top boxes, digital video recorders, personal video recorders, etc. FIG. 2 shows a set-top box 20 comprising a video signal encoder of the kind shown in FIG. 1. An analogue TV signal 21 is converted into an MPEG stream 22. The MPEG stream 22 might e.g. be displayed on a TV set 23. Furthermore, the MPEG stream 22 might e.g. be stored on some kind of storage device. The video signal encoder is adapted for extracting blanking interval information 24 from the analogue TV signal 21. In case the blanking interval information comprises closed captions (CC) or teletext (TTX), the blanking interval information may be shown on the TV set 23 together with the audiovisual content. In case the blanking interval information comprises information like e.g. VPS (video programming system) data, this auxiliary information might be used for programming the set-top box 20 or the personal video recorder.

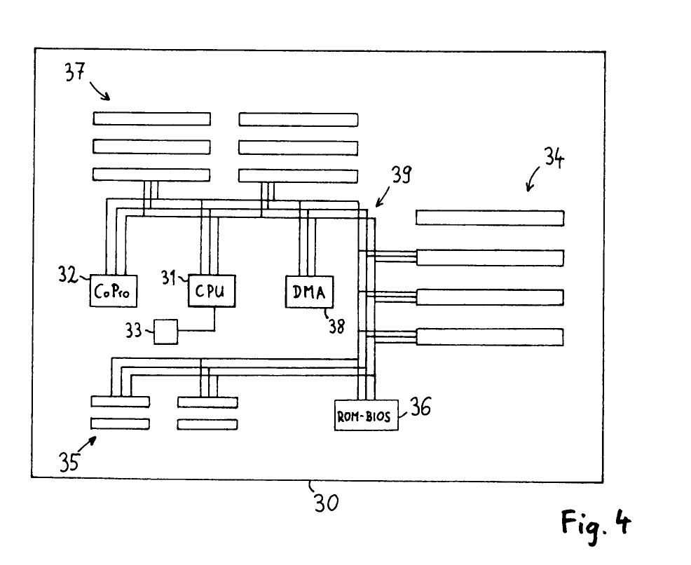

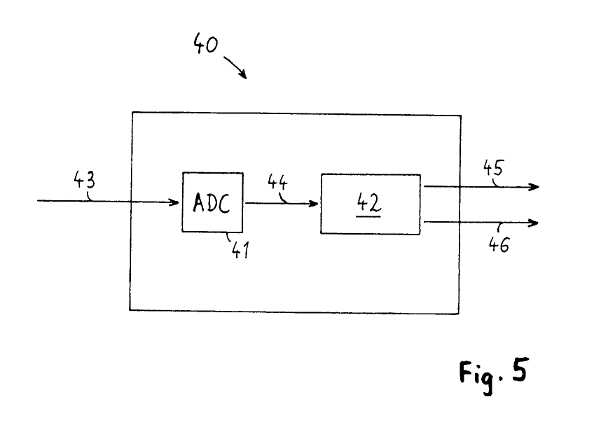

FIG. 3, FIG. 4 and FIG. 5 relate to another embodiment of the present invention. In FIG. 3 there is shown an apparatus 25, e.g. a PC (personal computer), with which a method ac-cording to an embodiment of the invention can be performed. Alternatively, e.g., a work-station, a laptop computer, or any other kind of computer, e.g., a handheld computer might be used.

As can be seen in FIG. 3, the apparatus 25 comprises respective input means, e.g., a key-board 26 (and/or a mouse (not shown)). The apparatus 25 further comprises output means like e.g. a monitor 27. An analogue television signal 28 is provided to the apparatus 25. The analogue television signal 28 might e.g. be a PAL-, NTSC-, or SECAM-signal, or any other kind of analogue colour or black and white TV signal.

Into a housing 29 of the apparatus 1, a respective motherboard might be mounted, e.g. the motherboard 30 shown in FIG. 4. The motherboard 30 might e.g. comprise one or several CPUs 31, a co-processing component (CoPro) 32, a quartz or crystal oscillator 33, several plug-in places or card slots 34, and several memory components, e.g. cache memory components 35, a ROM-BIOS component 36, several memory banks 37, etc., and a Direct Memory Access (DMA) component 38.

As can be seen from FIG. 4, the several components of the motherboard 30 are linked by one or several bus systems comprising e.g. respective data, address, and/or control buses, e.g., a PCI bus system 39.

Further, into the above memory bank 37, one or several SIMM modules can be plugged, each carrying several RAM components, e.g., respective DRAM (or VRAM) memory chips.

In addition, into the plug-in places 34—optionally—one or several peripheral component cards can be plugged in, e.g., respective sound cards, video and/or audio data processing cards (e.g. the video and/or audio data processing card 40 shown in FIG. 5), graphic data processing cards, modem cards, etc.

For example, a graphic data processing card (which might e.g. comprise one or several non-programmable data processing chips, and one or several memory chips, etc.), might e.g. control the data interchanged between one or several components on the motherboard 30, and a monitor (e.g. the monitor 27 shown in FIG. 3).

With the video and/or audio data processing card 40 shown in FIG. 5, and plugged into one of the plug-in places 34, an analogue television signal 28 fed to the apparatus 25 (see e.g. FIG. 3) is transformed into one or more digital signals. As is shown in FIG. 5, the video and/or audio data processing card 40 comprises an analogue-to-digital converter 41, which samples the analogue television signal provided on a respective line or lines 43, and out-puts respective digital signals on a line or lines 44.

The signals on line 44 are provided to a chip 42. The chip 42 (and/or the card 40) might comprise one or several memory units. Further, the chip 42 might comprise one or several processing units (e.g., more than two or three processing units).

On the above memory unit or units, a software code—in particular, an assembler software code—is stored which when executed on the one or several processing units causes the processing unit(s) to perform one or several procedures, in the course of which, as is shown in FIG. 5, a respective MPEG bit stream is derived from the digital signal present on line 44, and output on an output line 45.

The MPEG bit stream (similar to conventional MPEG bit streams) might be used to control the output of the monitor 27 of the apparatus 25 (here: a PC) shown in FIG. 3, which thus outputs images corresponding to those output by a conventional analogue TV set if the analogue TV signal had not been input into the apparatus 25, but into an ordinary, analogue TV set.

Further, the above software code (and/or an additional software code) stored on the above memory unit or units, when executed on the one or several processing units causes the processing unit(s) to perform one or several (additional) procedures, in the course of which, as is shown in FIG. 5, additional information comprised in the analogue TV signal present on line 43 is extracted, and output—in the form of a digital signal—on an output line 46.

The additional information might be vertical blanking interval (VBI) information transmit-ted during the vertical blanking interval, and/or horizontal blanking interval (HBI) information transmitted during the horizontal blanking interval.

The additional information might e.g. comprise closed captions (CC), teletext (TTX), wide screen signaling (WSS), copy generation management system (CGMS), video programming system (VPS), program delivery control (PDC). The additional information might e.g. comprise any other type of auxiliary blanking interval information.

The digital signal output on line 46 might be used to control the output of the monitor 27 of the apparatus 25 (here: a PC) shown in FIG. 3 such that the above additional information contained in the analogue TV signal, and extracted by the chip 42—if desired by the user—is output on the monitor 27.

Advantageously, in addition to what was described above, several other additional procedures are performed by the chip 42, also, e.g., respective filtering, etc.

Further, in an embodiment, the above software code (and/or an additional software code) stored on the above memory unit or units, when executed on the one or several processing units of the chip 42 causes the processing unit(s) to perform one or several (additional) procedures, in the course of which it is determined to which standard (e.g., the PAL-, NTSC-, or SECAM-standard) the analogue TV signal present on line(s) 43 refers to.

Depending on this determination—dynamically—a different software code might be used for the above steps (i.e., either a software code written for a PAL-, or a software code writ-ten for a NTSC-, or a software code written for a SECAM-signal), such that—independent of the respective standard—a respective MPEG bit stream is derived from the analogue TV signal present on line 43, and output on line 45, and the additional information comprised in the analogue television signal present on line 43 is extracted and output on line 46.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A blanking interval information decoder adapted for decoding blanking interval information transmitted in a video signal, the blanking interval information decoder comprising:
a processing unit;
a memory adapted for storing at least one of code and data;
a set of blanking interval decoding routines stored in the memory, with each of the blanking interval decoding routines being adapted for decoding a certain type of blanking interval information of a certain video standard.

2. The blanking interval information decoder of claim 1, further comprising an identification routine stored in the memory, said identification routine being adapted for detecting the one or more types of encoded blanking interval information, and for activating, in accordance with the detected types of blanking interval information, corresponding blanking interval decoding routines.

3. The blanking interval information decoder of claim 2, wherein the identification routine is adapted for analyzing active lines of the blanking interval, and for activating those blanking interval decoding routines adapted for decoding the types of blanking interval information contained in the blanking interval.

4. The blanking interval information decoder of claim 2, wherein the identification routine is further adapted for analyzing the video signal's respective video standard.

5. The blanking interval information decoder of claim 1, wherein the video standard is one of: PAL, NTSC, SECAM, or any other type of video standard.

6. The blanking interval information decoder of claim 1, wherein the set of blanking interval decoding routines and the identification routine are implemented as software routines.

7. The blanking interval information decoder of claim 1, wherein the set of blanking interval decoding routines and the identification routine are realized in microcode.

8. The blanking interval information decoder of claim 1, wherein the blanking interval in-formation is one of: vertical blanking interval (VBI) information and horizontal blanking interval (HBI) information.

9. The blanking interval information decoder of claim 1, wherein the memory is a RAM memory.

10. The blanking interval information decoder of claim 1, further comprising an updating module adapted for downloading at least one of: new blanking interval decoding routines adapted for decoding previously unknown types of blanking interval information and up-date versions of existing blanking interval decoding routines.

11. The blanking interval information decoder of claim 1, wherein the blanking interval information comprises one or more of the following types: closed captions (CC), teletext (TTX), wide screen signalling (WSS), copy generation management system (CGMS), video programming system (VPS), program delivery control (PDC), or any other type of blanking interval information.

12. The blanking interval information decoder of claim 1, wherein the blanking interval information decoder is implemented as an integrated circuit.

13. The blanking interval information decoder of claim 1, wherein the blanking interval information decoder is part of a set-top box, a personal video recorder, a digital video recorder, a digital television set, a video and/or audio processing card.

14. A video signal encoding unit comprising
an extraction module adapted for extracting audiovisual content and blanking interval information from a video signal;
a blanking interval information decoder according to claim 1, said blanking interval information decoder being adapted for decoding blanking interval in-formation;
an audiovisual information converter adapted for converting the audiovisual content into a digital audio/video format.

15. The video signal encoding unit of claim 14, further comprising an analogue-to-digital converter adapted for converting the video signal into a sequence of digital sample values.

16. The video signal encoding, unit of claim 14, wherein the audiovisual information converter is an MPEG encoding module adapted for converting the audiovisual content into an MPEG stream.

17. The video signal encoding unit of claim 14, wherein the video signal encoding unit is adapted for inserting decoded blanking interval information into the digital audio/video format.

18. The video signal encoding unit of claim 14, wherein the audiovisual information converter is implemented as a software routine stored in the memory.

19. The video signal encoding unit of claim 14, wherein the audiovisual information converter is implemented as a hardware unit.

20. The video signal encoding unit of claim 14, wherein the video signal encoding unit is implemented as a system on a chip.

21. The video signal encoding unit of claim 14, wherein the video signal encoding unit is part of a set-top box, a personal video recorder, a digital video recorder, an audio and/or video processing card.

22. A blanking interval information encoder adapted for encoding blanking interval information, the blanking interval information encoder comprising:
a processing unit;
a memory adapted for storing at least one of code and data;
a set of blanking interval encoding routines stored in the memory, with each of the blanking interval encoding routines being adapted for encoding the blanking interval information according to a certain type and video standard, and
a selection routine stored in the memory, said selection routine being adapted for activating, in accordance with a desired type of blanking interval information, a corresponding blanking interval encoding routine.

23. A method for extracting and decoding blanking interval information transmitted as part of a video signal, the method comprising steps of:
extracting blanking interval information from the video signal,
identifying one or more types of blanking interval information contained in the blanking interval,
activating, for each identified type of blanking interval information, a corresponding blanking interval decoding routine adapted for decoding the respective type of blanking interval information.

24. The method of claim 23, further comprising steps of performing an analogue-to-digital conversion of the video signal and converting the video signal into a sequence of digital sample values.

25. The method of claim 23, further comprising a step of extracting audiovisual content from the video signal.

26. The method of claim 25, further comprising a step of converting the audiovisual con-tent into a digital audio/video format.

27. The method of claim 25, further comprising a step of converting the audiovisual con-tent into an MPEG stream.

28. The method of claim 23, further comprising a step of analyzing the video signal's respective video standard.

29. The method of claim 23, further comprising steps of analyzing active lines of the blanking interval, and activating those blanking interval decoding routines adapted for de-coding the types of blanking interval information contained in the blanking interval.

30. The method of claim 23, further comprising a step of executing an identification routine adapted for analyzing the types of blanking interval information, said identification routine being adapted for activating, for each identified type of blanking interval information, a corresponding blanking interval decoding routine adapted for decoding the respective type of blanking interval information.

31. The method of claim 23, wherein the set of blanking interval decoding routines are implemented as software routines stored in a memory.

32. The method of claim 23, wherein the blanking interval information is one of: vertical blanking interval (VBI) information and horizontal blanking interval (HBI) information.

33. A method for updating blanking interval decoding routines stored in a memory, each of the blanking interval decoding routines being adapted for decoding a certain type of blanking interval information, the method comprising a step of:
downloading at least one of: new blanking interval decoding routines adapted for decoding previously unknown types of blanking interval information and update version of existing blanking interval decoding routines.
